(19) United States
(12) Patent Application Publication
(10) Pub. No.: US 2019/0111852 A1
(43) Pub. Date: Apr. 18, 2019

(54) Vehicle Sun Visor Multiple Glasses Storage Apparatus

(71) Applicant: Jovan Leon Thompson, Garfield Heights, OH (US)

(72) Inventor: Jovan Leon Thompson, Garfield Heights, OH (US)

(21) Appl. No.: 16/159,622

(22) Filed: Oct. 13, 2018

Related U.S. Application Data
(63) Continuation of application No. 62/572,466, filed on Oct. 14, 2017.

(51) Int. Cl. B60R 7/08; B60R 7/05; G02C 3/04; A44B 18/00

(52) U.S. Cl. CPC B60R 7/082; A44B 18/0073; G02C 3/04; B60R 7/05

(57) ABSTRACT

A multiple glasses storage apparatus comprising articles, means, and methods. A storage case comprising a single open ended tubular compartment sandwiched by flexible material creating an interior and exterior access flap. A means for coupling the interior and exterior access flap forming a coupled access flap. A means for fastening the coupled access flap creating an opening access hole. A rectangular connecting baseplate comprising two slab faces. A rectangular connecting strap comprising two strap faces. A means for coupling the first strap face with the second strap face. A means for coupling the second strap face with the first slab face. A means for coupling the second slab face with the storage case. A method of fastening and opening the coupled access flap. Methods of using one or more connecting straps with one or more storage cases with or without the connecting baseplate all in cooperation with each other.

### CROSS-REFERENCE TO RELATED APPLICATIONS

This application is a continuation of prior Application No. 62/572,466, filed Oct. 14, 2017.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

This invention relates generally to a multiple glasses storage apparatus comprising articles, means, and methods and relates specifically to a vehicle sun visor multiple glasses storage apparatus comprising articles, means, and methods.

Many people today own multiple pairs of eyeglasses and sunglasses and store them in their vehicles to be used quickly to aid in driving during times of low visibility such as during storms, after nightfall, or when driving in intense sunlight. Additionally many people own various colors and styles of eyeglasses and sunglasses and store them in their vehicles to be used as a fashion accessory. Securely storing multiple pairs of eyeglasses and sunglasses in a vehicle while at the same time having easy access to the eyeglasses and sunglasses is currently very problematic as many newer vehicles come equipped with only a single storage compartment for glasses and many older vehicles do not come equipped with a storage compartment for glasses at all. As a result of the insufficient storage compartments for glasses available in vehicles today, many people create makeshift storage solutions and store multiple pairs of eyeglasses and sunglasses in two general ways.

One general makeshift storage solution seen is where eyeglasses and sunglasses are placed into cases and stored in the center console, in the glove compartment, or out on the open visible surfaces of the vehicle. One problem with this storage solution is that much of the space is taken up in the center console and glove compartment, which makes storing other necessary items in these locations difficult or impossible. Also with this storage solution gaining access to eyeglasses and sunglasses is very difficult as it requires users to open the center console or glove compartment, remove the case, open the case, remove the eyeglasses or sunglasses from the case, close the case, return the case, and close the center console or glove compartment. Problems seen with storing eyeglasses and sunglasses in cases out on the open visible surfaces of the vehicle are that this storage solution only suboptimally improves accessibility and that this storage solution creates dangers and inconveniences of case movement around the vehicle as the vehicle is in motion. While this storage solution does provide security to prevent damage to the eyeglasses and sunglasses and to minimize the risk of breaking and entering into the vehicle it does not provide easy accessibility to the eyeglasses and sunglasses.

The other general makeshift storage solution seen is where eyeglasses and sunglasses are stored without a case in the center console, in the glove compartment, or out on the open visible surfaces of the vehicle. One problem with this storage solution is that much of the space is taken up in the center console and glove compartment, which makes storing other necessary items in these locations difficult or impossible. Also with this storage solution problems are seen such as diminished protection from scratches, impacts, and prolonged direct sunlight. Additional problems seen with storing eyeglasses and sunglasses without cases out on the open visible surfaces of the vehicle are that this storage solution leaves eyeglasses and sunglasses visible to people walking by the vehicle which may entice a burglary breaking and entering into the vehicle if the eyeglasses or sunglasses are perceived as expensive or desirable and that this storage solution creates dangers and inconveniences of eyeglasses and sunglasses moving around the vehicle as the vehicle is in motion. While this storage solution provides easy accessibility to the eyeglasses and sunglasses it does not provide security to prevent damage to the eyeglasses and sunglasses or to minimize the risk of breaking and entering into the vehicle.

Thus, there remains a considerable need generally for a multiple glasses storage apparatus comprising articles, means, and methods and a need specifically for a vehicle sun visor multiple glasses storage apparatus comprising articles, means, and methods that can both securely store multiple pairs of eyeglasses and sunglasses and that can give easy access to these eyeglasses and sunglasses.

### BRIEF SUMMARY OF THE INVENTION

The present invention, as disclosed hereafter in this application, considers the market needs and all other information provided in the preceding background and is therefore directed to providing articles for a vehicle sun visor multiple glasses storage apparatus and to providing means and methods of using the apparatus that meet these market needs.

In order to meet the aforementioned market needs, in the preferred embodiment, the apparatus is configured such that one or more of the connecting straps are coupled onto a vehicle sun visor or other desired substrate, which straps are then coupled with the connecting baseplate, which connecting baseplate is then coupled with one or more of the storage cases.

In order to meet the aforementioned market needs, in another embodiment, the apparatus is configured such that one or more of the connecting straps are coupled onto a vehicle sun visor or other desired substrate, which straps are then coupled with one or more of the storage cases.

The subsequent paragraphs in this summary have been provided as a general overview of the claims and are not intended to limit the scope of the claims.

A storage case that is substantially a thin-walled and tube-shaped compartment open on one end and sandwiched by an interior lining and an exterior lining running the length of the case. The interior and exterior lining each extends significantly beyond the compartment open end creating an interior access flap and an exterior access flap.

A means for coupling the interior access flap with the exterior access flap, forming a coupled access flap, comprising the use of stitching or the use of an adhesive or the use of both switching and an adhesive.

A means for fastening the coupled access flap comprising the use of cooperative fabric hook and loop pieces or the use of cooperative magnets with opposite poles or the use of cooperative male and female snap buttons. When fastened in any of these ways there is an opening access hole formed.

A connecting baseplate comprising a slab made of natural or synthetic or composite material that is substantially rectangular in shape with 2 transverse edges, two longitudinal edges, and two faces.

A connecting strap comprising flexible material that is substantially rectangular in shape with 2 transverse edges, two longitudinal edges, and two faces.

A means for coupling the first strap face with the second strap face comprising the use of cooperative fabric hook and loop pieces or the use of cooperative magnets with opposite poles or the use of cooperative male and female snap buttons.

A means for coupling the second strap face with the first slab face comprising the use of cooperative fabric hook and loop pieces or the use of cooperative magnets with opposite poles or the use of cooperative male and female snap buttons.

A means for coupling the second slab face with the storage case comprising the use of cooperative fabric hook and loop pieces or the use of cooperative magnets with opposite poles or the use of cooperative male and female snap buttons.

A method of fastening and opening the coupled access flap comprising a fastening pinch action with the thumb and fingers over the coupled access flap exterior lining face to bring the cooperative fabric hook and loop pieces or cooperative magnets with opposite poles or cooperative male and female snap button into contact with each other. An opening reverse-pinch action with the thumb and fingers inside the opening access hole to separate the cooperative fabric hook and loop pieces or cooperative magnets with opposite poles or cooperative male and female snap button from contact with each other.

A method of using one or more of the connecting straps, the connecting baseplate, and one or more of the storage cases in cooperation with each other comprising coupling one or more of the connecting straps onto a vehicle sun visor or other desired substrate, coupling the connecting baseplate with one or more of the connecting straps, and coupling one or more of the storage cases with the connecting baseplate.

A method of using one or more of the connecting straps and one or more of the storage cases in cooperation with each other comprising coupling one or more of the connecting straps onto a vehicle sun visor or other desired substrate and coupling one or more of the storage cases with the connecting straps.

The preceding paragraphs in this summary have been provided as a general overview, and are not intended to limit the scope of the claims. The described embodiments, claims, and further advantages will be best understood by reference to the detailed description, claims, and brief description of the drawings.

### BRIEF DESCRIPTION OF THE SEVERAL VIEWS OF THE DRAWING(S)

The above brief summary of the invention and other features, aspects, and advantages of the present invention will become better understood with regard to the following descriptions, appended claims, and accompanying drawings.

FIG. 1 illustrates a perspective side view of the compartment anterior end, the compartment posterior end, the open clearance at the anterior end, the circumference of the anterior end, and the circumference of the posterior end according to one embodiment.

FIG. 2 illustrates a perspective side view of the compartment anterior end, the compartment posterior end, the circumference of the anterior end, and the circumference of the posterior end according to one embodiment. FIG. 2 illustrates the opposite longitudinal end illustrated in FIG. 1.

FIG. 3 illustrates a top view of the interior surface lining showing the first interior lining face, the first transverse interior lining edge along the top, the second transverse interior lining edge along the bottom, the first longitudinal interior lining edge along the left side, and the second longitudinal interior lining edge along the right side according to one embodiment.

FIG. 4 illustrates a top view of the interior surface lining showing the second interior lining face, the first transverse interior lining edge along the top, the second transverse interior lining edge along the bottom, the first longitudinal interior lining edge along the right side, and the second longitudinal interior lining edge along the left side according to one embodiment. FIG. 4 illustrates the opposite interior lining face as illustrated in FIG. 3 by rotating FIG. 3 180-degrees around the longitudinal axis to reverse the left and right positions of the longitudinal edges.

FIG. 5 illustrates a perspective side view of the compartment anterior end where the interior surface lining is deeply inserted into the compartment and where the first interior lining face is coupled to about the whole interior surface of the compartment according to one embodiment. The compartment posterior end, the circumference of the anterior end, the circumference of the posterior end, the first transverse interior lining edge, the second interior lining face, and the interior access flap are also clearly distinguishable in this illustration.

FIG. 6 illustrates a perspective side view of the compartment where the interior surface lining is deeply inserted into the compartment, where the first interior lining face is coupled to about the whole interior surface of the compartment, where the second transverse interior lining edge is oriented substantially in alignment with and in a longitudinally parallel plane to the circumference of the posterior end, and where the first transverse interior lining edge is oriented in a longitudinally parallel plane to the circumference of the anterior end and longitudinally externally beyond the anterior end of the compartment sufficiently distant that it is about 70% of the outer diameter length of the compartment away creating an interior access flap according to one embodiment. FIG. 6 illustrates a more direct perspective side view of FIG. 5.

FIG. 7 illustrates a perspective side view of the compartment posterior end where the interior surface lining is deeply inserted into the compartment and where the first interior lining face is coupled to about the whole interior surface of the compartment according to one embodiment. The compartment anterior end, the circumference of the anterior end, the circumference of the posterior end, the first transverse interior lining edge, and the interior access flap are also clearly distinguishable in this illustration. FIG. 7 illustrates a more posterior perspective side view of FIG. 5 and FIG. 6.

FIG. 8 illustrates a top view of the exterior surface lining showing the first exterior lining face, the first transverse exterior lining edge along the top, the second transverse exterior lining edge along the bottom, the first longitudinal exterior lining edge along the left side, and the second longitudinal exterior lining edge along the right side according to one embodiment.

FIG. 9 illustrates a top view of the exterior surface lining showing the second exterior lining face, the first transverse exterior lining edge along the top, the second transverse exterior lining edge along the bottom, the first longitudinal exterior lining edge along the right side, and the second longitudinal exterior lining edge along the left side according to one embodiment. FIG. 9 illustrates the opposite side exterior lining face as illustrated in FIG. 8 by rotating FIG. 8 180-degrees around the longitudinal axis to reverse the left and right positions of the longitudinal edges.

FIG. 10 illustrates a perspective side view of the compartment anterior end where the first exterior lining face of the exterior surface lining is coupled to about the whole exterior surface of the compartment according to one embodiment. The compartment posterior end, the circumference of the anterior end, the first transverse exterior lining edge, the second transverse exterior lining edge, the second exterior lining face, the exterior access flap, and portions of adhesive are also clearly distinguishable in this illustration.

FIG. 11 illustrates a perspective side view of the compartment where the first exterior lining face of the exterior surface lining is coupled to about the whole exterior surface of the compartment, where the second transverse exterior lining edge is oriented substantially in alignment with and in a longitudinally parallel plane to the circumference of the posterior end, and where the first transverse exterior lining edge is oriented in a longitudinally parallel plane to the circumference of the anterior end and longitudinally externally beyond the anterior end of the compartment sufficiently distant that it is about 70% of the outer diameter length of the compartment away creating an exterior access flap according to one embodiment. FIG. 11 illustrates a more direct perspective side view of FIG. 10.

FIG. 12 illustrates a perspective side view of the compartment posterior end where the first exterior lining face of the exterior surface lining is coupled to about the whole exterior surface of the compartment according to one embodiment. The compartment anterior end, the compartment posterior end, the circumference of the anterior end, the circumference of the posterior end, the first transverse exterior lining edge, the second transverse exterior lining edge, the second exterior lining face, the exterior access flap, and portions of adhesive are also clearly distinguishable in this illustration. FIG. 12 illustrates a more posterior perspective side view of FIG. 10 and FIG. 11.

FIG. 13 illustrates a perspective side view of the storage case anterior end where a section of stitching transverses the interior access flap and the exterior access flap as a means to create a coupled access flap and where portions of adhesive are applied between the interior access flap and the exterior access flap as a means to create a coupled access flap which is comprised of a coupled access flap interior lining face and a coupled access flap exterior lining face according to one embodiment.

FIG. 14 illustrates a perspective top view inside the storage case anterior end where a section of stitching transverses the interior access flap and the exterior access flap as a means to create a coupled access flap and where portions of adhesive are applied between the interior access flap and the exterior access flap as a means to create a coupled access flap which is comprised of a coupled access flap interior lining face and a coupled access flap exterior lining face according to one embodiment. FIG. 14 is a different view of FIG. 13.

FIG. 15 illustrates a perspective side view of the storage case anterior end where an access flap fabric hook fastener piece and an access flap fabric loop fastener piece are coupled to the coupled access flap interior lining face in a corporate way creating a means for fastening the coupled access flap according to the best mode embodiment.

FIG. 16 illustrates a perspective side view of the storage case anterior end where an access flap positive pole magnet member and an access flap negative pole magnet member are coupled to the coupled access flap interior lining face in a corporate way creating a means for fastening the coupled access flap according to one embodiment.

FIG. 17 illustrates a perspective side view of the storage case anterior end where an access flap male snap button member and an access flap female snap button member are coupled to the coupled access flap interior lining face in a corporate way creating a means for fastening the coupled access flap according to one embodiment.

FIG. 18 illustrates a top view of the connecting baseplate showing the first slab face, the first transverse slab edge along the left side, the second transverse slab edge along the right side, the first longitudinal slab edge along the top, and the second longitudinal slab edge along the bottom according to the best mode embodiment. This embodiment also illustrates the cooperative first interface fabric loop fastener pieces coupled to the connecting baseplate that provide a means for coupling the first slab face with the second strap face by cooperating with the first interface fabric hook fastener piece.

FIG. 19 illustrates a top view of the connecting baseplate showing the second slab face, the first transverse slab edge along the right side, the second transverse slab edge along the left side, the first longitudinal slab edge along the top, and the second longitudinal slab edge along the bottom according to the best mode embodiment. This embodiment also illustrates the cooperative second interface fabric hook fastener pieces coupled to the connecting baseplate that provide a means for coupling the second slab face with the storage case by cooperating with the second interface fabric loop fastener piece. FIG. 19 illustrates the opposite side slab face as illustrated in FIG. 18 by rotating FIG. 18 180-degrees around the transverse axis to reverse the left and right positions of the transverse edges.

FIG. 20 illustrates a top view of the connecting baseplate showing the first slab face, the first transverse slab edge along the left side, the second transverse slab edge along the right side, the first longitudinal slab edge along the top, and the second longitudinal slab edge along the bottom according to one embodiment. This embodiment also illustrates the cooperative first interface negative pole magnet members coupled to the connecting baseplate that provide a means for coupling the first slab face with the second strap face by cooperating with the first interface positive pole magnet member.

FIG. 21 illustrates a top view of the connecting baseplate showing the second slab face, the first transverse slab edge along the right side, the second transverse slab edge along the left side, the first longitudinal slab edge along the top, and the second longitudinal slab edge along the bottom according to one embodiment. This embodiment also illustrates the cooperative second interface positive pole magnet members coupled to the connecting baseplate that provide a means for coupling the second slab face with the storage case by cooperating with the second interface negative pole magnet member. FIG. 21 illustrates the opposite side slab face as illustrated in FIG. 20 by rotating FIG. 20 180-degrees around the transverse axis to reverse the left and right positions of the transverse edges.

FIG. 22 illustrates a top view of the connecting baseplate showing the first slab face, the first transverse slab edge along the left side, the second transverse slab edge along the right side, the first longitudinal slab edge along the top, and the second longitudinal slab edge along the bottom according to one embodiment. This embodiment also illustrates the cooperative first interface male snap button members coupled to the connecting baseplate that provide a means for coupling the first slab face with the second strap face by cooperating with the first interface female snap button members.

FIG. 23 illustrates a top view of the connecting baseplate showing the second slab face, the first transverse slab edge along the right side, the second transverse slab edge along the left side, the first longitudinal slab edge along the top, and the second longitudinal slab edge along the bottom according to one embodiment. This embodiment also illustrates the cooperative second interface female snap button members coupled to the connecting baseplate that provide a means for coupling the second slab face with the storage case by cooperating with the second interface male snap button members. FIG. 23 illustrates the opposite side slab face as illustrated in FIG. 22 by rotating FIG. 22 180-degrees around the transverse axis to reverse the left and right positions of the transverse edges.

FIG. 24 illustrates a top view of two connecting straps where the first strap located on the top shows the second strap face, the first transverse strap edge along the left side, the second transverse strap edge along the right side, the first longitudinal strap edge along the top, and the second longitudinal strap edge along the bottom according to the best mode embodiment. The second connecting strap located on the bottom illustrates the opposite side of the connecting strap located on the top and shows the first strap face, the first transverse strap edge along the left side, the second transverse strap edge along the right side, the first longitudinal strap edge along the bottom, and the second longitudinal strap edge along the top according to the best mode embodiment. This embodiment illustrates the cooperative strap face coupling fabric hook fastener piece and strap face coupling fabric loop fastener piece coupled to the connecting straps that provide a means for coupling the first strap face with the second strap face and a first interface fabric hook fastener piece for coupling the second strap face with the first slab face.

FIG. 25 illustrates a top view of two connecting straps where the first strap located on the top shows the second strap face, the first transverse strap edge along the left side, the second transverse strap edge along the right side, the first longitudinal strap edge along the top, and the second longitudinal strap edge along the bottom according to one embodiment. The second connecting strap located on the bottom illustrates the opposite side of the connecting strap located on the top and shows the first strap face, the first transverse strap edge along the left side, the second transverse strap edge along the right side, the first longitudinal strap edge along the bottom, and the second longitudinal strap edge along the top according to one embodiment. This embodiment illustrates the cooperative strap face coupling positive pole magnet member and a strap face coupling negative pole magnet member coupled to the connecting straps that provide a means for coupling the first strap face with the second strap face and a first interface positive pole magnet member for coupling the second strap face with the first slab face.

FIG. 26 illustrates a top view of two connecting straps where the first strap located on the top shows the second strap face, the first transverse strap edge along the left side, the second transverse strap edge along the right side, the first longitudinal strap edge along the top, and the second longitudinal strap edge along the bottom according to one embodiment. The second connecting strap located on the bottom illustrates the opposite side of the connecting strap located on the top and shows the first strap face, the first transverse strap edge along the left side, the second transverse strap edge along the right side, the first longitudinal strap edge along the bottom, and the second longitudinal strap edge along the top according to one embodiment. This embodiment illustrates the cooperative strap face coupling female snap button members and strap face coupling male snap button members coupled to the connecting straps that provide a means for coupling the first strap face with the second strap face and first interface female snap button members for coupling the second strap face with the first slab face.

FIG. 27 illustrates a perspective side view of the storage case anterior end as shown in FIG. 15 but that now additionally illustrates the second interface fabric loop fastener piece coupled to the storage case exterior creating a means of coupling the storage case with the second interface fabric hook fastener piece of the connecting baseplate or with the first interface fabric hook fastener piece of the connecting strap according to the best mode embodiment.

FIG. 28 illustrates a perspective side view of the storage case posterior end as a more posterior perspective side view of FIG. 27.

FIG. 29 illustrates a perspective side view of the storage case anterior end as shown in FIG. 16 but that now additionally illustrates the second interface negative pole magnet member coupled to the storage case exterior creating a means of coupling the storage case with the second interface positive pole magnet members of the connecting baseplate or with the first interface positive pole magnet member of the connecting strap according to one embodiment.

FIG. 30 illustrates a perspective side view of the storage case posterior end as a more posterior perspective side view of FIG. 29.

FIG. 31 illustrates a perspective side view of the storage case anterior end as shown in FIG. 17 but that now additionally illustrates second interface male snap button members coupled to the storage case exterior creating a means of coupling the storage case with the second interface female snap button members of the connecting baseplate or with the first interface female snap button members of the connecting strap according to one embodiment.

FIG. 32 illustrates a perspective side view of the storage case posterior end as a more posterior perspective side view of FIG. 31.

FIG. 33 illustrates a perspective top view inside the storage case anterior end and shows a method of fastening the coupled access flap that involves a fastening pinch action with the thumb and fingers over the coupled access flap exterior lining face to bring the access flap fabric hook fastener piece and the access flap fabric loop fastener piece into contact with each other according to the best mode embodiment. FIG. 33 is a different view of FIG. 27.

FIG. 34 illustrates a perspective top view inside the storage case anterior end and shows a continuation of the method of fastening the coupled access flap initiated in FIG. 33.

FIG. 35 illustrates a perspective top view of the storage case anterior end and shows the opening access hole created when the coupled access flap is fastened according to the best mode embodiment.

FIG. 36 illustrates a perspective top view of the storage case anterior end and shows a method of opening the coupled access flap that involves an opening reverse-pinch action with the thumb and fingers inside the opening access hole to separate the access flap fabric hook fastener piece and the access flap fabric loop fastener piece from contact with each other according to the best mode embodiment.

FIG. 37 illustrates a perspective top view of the storage case anterior end and shows a continuation of the method of opening the coupled access flap initiated in FIG. 36.

FIG. 38 illustrates a perspective front view of the storage case, connecting baseplate, and connecting straps coupled to a substrate showing a method of using all in cooperation with each other according to the best mode embodiment. One or more connecting straps are coupled onto the desired substrate where the connecting baseplate is coupled with the one or more connecting straps where one or more storage cases are coupled with the connecting baseplate.

FIG. 39 illustrates a perspective left side view of the storage case, connecting baseplate, and connecting straps coupled to a substrate showing a method of using all in cooperation with each other according to the best mode embodiment. One or more connecting straps are coupled onto the desired substrate where the connecting baseplate is coupled with the one or more connecting straps where one or more storage cases are coupled with the connecting baseplate. FIG. 39 illustrates a more perspective left side view of FIG. 38 and more clearly shows the connecting straps coupled to the desired substrate.

FIG. 40 illustrates a perspective right side view of the storage case, connecting baseplate, and connecting straps coupled to a substrate showing a method of using all in cooperation with each other according to the best mode embodiment. One or more connecting straps are coupled onto the desired substrate where the connecting baseplate is coupled with the one or more connecting straps where one or more storage cases are coupled with the connecting baseplate. FIG. 40 illustrates a more perspective right side view of FIG. 38 and more clearly shows the connecting straps coupled to the desired substrate.

FIG. 41 illustrates a perspective rear view of the storage case, connecting baseplate, and connecting straps coupled to a substrate showing a method of using all in cooperation with each other according to the best mode embodiment. One or more connecting straps are coupled onto the desired substrate where the connecting baseplate is coupled with the one or more connecting straps where one or more storage cases are coupled with the connecting baseplate. FIG. 41 illustrates a more perspective rear view of FIG. 38 and more clearly shows the connecting straps coupled to the desired substrate.

FIG. 42 illustrates a perspective front view of the storage case and connecting strap coupled to a substrate showing a method of using all in cooperation with each other according to the best mode embodiment. One or more connecting straps are coupled onto the desired substrate where one or more storage cases are coupled with the connecting straps.

FIG. 43 illustrates a perspective left side view of the storage case and connecting strap coupled to a substrate showing a method of using all in cooperation with each other according to the best mode embodiment. One or more connecting straps are coupled onto the desired substrate where one or more storage cases are coupled with the connecting straps. FIG. 43 illustrates a more perspective left side view of FIG. 42 and more clearly shows the connecting strap coupled to the desired substrate.

FIG. 44 illustrates a perspective rear view of the storage case and connecting strap coupled to a substrate showing a method of using all in cooperation with each other according to the best mode embodiment. One or more connecting straps are coupled onto the desired substrate where one or more storage cases are coupled with the connecting straps. FIG. 44 illustrates a more perspective rear view of FIG. 42 and more clearly shows the connecting strap coupled to the desired substrate.

### DETAILED DESCRIPTION OF THE INVENTION

Some embodiments of the present invention will now be described in further detail with reference to the accompanying drawings. In the drawings like reference numerals designate identical or corresponding parts, elements, means, or methods throughout the several views. This further detail of the embodiments is not intended to limit the invention to particular embodiments or modes and it should also be recognized that any equivalents, substitutes, and changes that do not depart from the spirit and scope of the invention are encompassed in the invention.

Unless defined otherwise, all terms used herein have the same meaning as commonly understood by one of ordinary skill in the art to which this invention disclosure belongs. It will also be understood that terms, such as those defined in commonly used dictionaries, should be interpreted as having a meaning that is in accord with their meaning in the context of the relevant art and the invention disclosure, and will not be interpreted in an abstract or overly formal sense unless expressly so defined herein.

It should be understood that the term “flexible material” means a material that can consist of natural materials, synthetic materials, or composite materials and can be manipulated to conform to many shapes and sizes.

It should be understood that the term “coupled to” means two elements that are connected in a semi-permanent way such as with an adhesive, welding, stitching, or screws making it very difficult or impossible to separate the elements.

It should be understood that the term “coupled with” means two elements that are connected in a non-permanent way such as with fabric hook and loop, magnets, or buttons making it easy to separate the elements.

It should be understood that the term “fabric hook and loop” refers to a fastening system, such as the Velcro brand for example, that functions to connect two elements in a non-permanent way by using a piece of the rough and scratchy “fabric hook” fabric coupled to one element and a piece of the soft and fuzzy “fabric loop” fabric coupled to the other element.

It should be understood that when an element is stated to have dimensions of “about 21% of the inner circumference length of said compartment”, what is meant is that the inner circumference of the compartment has a set length and that the element length is about 21% of that compartment inner circumference set length, including a range of plus 10% and minus 10%, such that the element can vary in range from 11% to 31% of that compartment inner circumference set length.

It should be understood that when an element is stated to have dimensions of “about 70% of the outer diameter length of said compartment away”, what is meant is that the outer diameter of the compartment has a set length and that the element length is about 70% of that compartment outer diameter set length, including a range of plus 10% and minus 10%, such that the element can vary in range from 60% to 80% of that compartment outer diameter set length.

It should be understood that the term “positive pole magnet member” refers to the positive magnet of a magnetic fastening system and the term “negative pole magnet member” refers to the negative magnet of a magnetic fastening system that functions together to connect two elements in a non-permanent way by coupling the “positive pole magnet member” to one element and the “negative pole magnet member” to the other element.

It should be understood that the term “male snap button member” refers to the male button of a button fastening system and the term “female snap button member” refers to the female button of a button fastening system that functions together to connect two elements in a non-permanent way by coupling the “male snap button member” to one element and the “female snap button member” to the other element.

It should be understood that the term “slab” means a substantially rectangular piece of material less than one inch thick that can consist of natural materials, synthetic materials, or composite materials.

It should be understood that the term “fastening pinch action” means contracting the thumb and fingers towards each other to create a compressional force which can be used to fasten the coupled access flap or fasten other elements.

It should be understood that the term “opening reverse-pinch action” means expanding the thumb and fingers away from each other to create a tensional force which can be used to open the opening access hole of the coupled access flap or open other elements.

It should be understood that the term “first interface” means the common connection space where the second strap face and the first slab face couple with each other.

It should be understood that the term “second interface” means the common connection space where the second slab face and the storage case couple with each other.

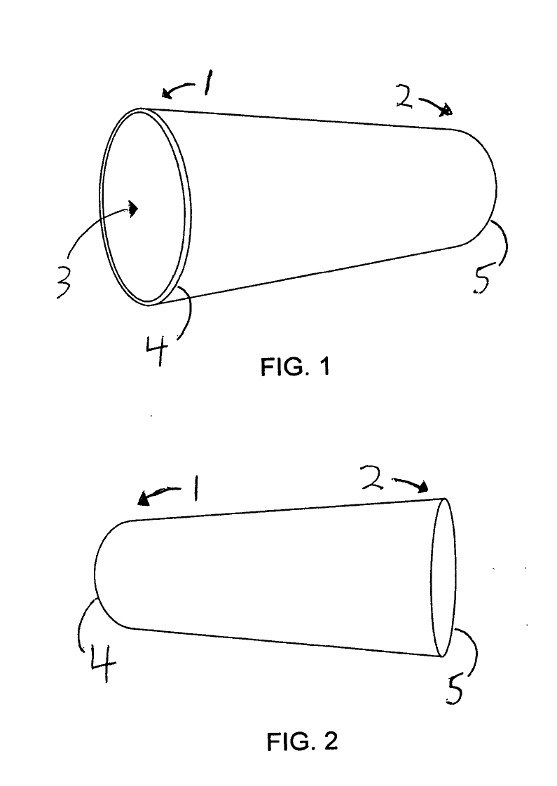

FIG. 1 illustrates a perspective side view of the compartment anterior end 1, the compartment posterior end 2, the open clearance at the anterior end 3, the circumference of the anterior end 4, and the circumference of the posterior end 5 according to one embodiment.

FIG. 2 illustrates a perspective side view of the compartment anterior end 1, the compartment posterior end 2, the circumference of the anterior end 4, and the circumference of the posterior end 5 according to one embodiment. FIG. 2 illustrates the opposite longitudinal end illustrated in FIG. 1.

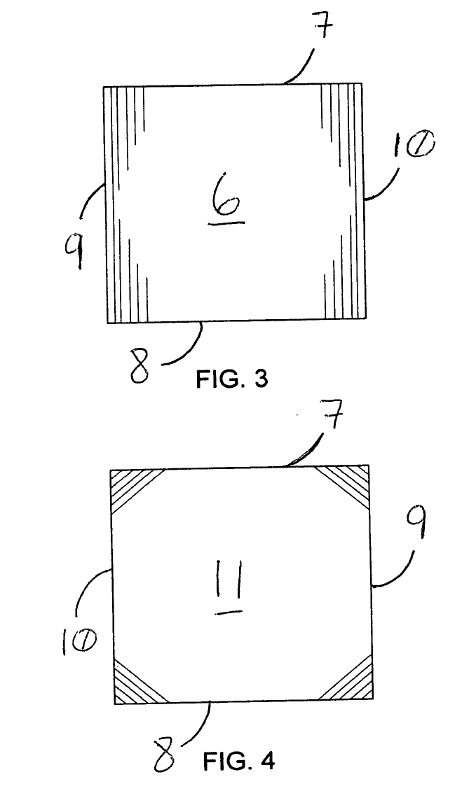

FIG. 3 illustrates a top view of the interior surface lining showing the first interior lining face 6, the first transverse interior lining edge 7, the second transverse interior lining edge 8, the first longitudinal interior lining edge 9, and the second longitudinal interior lining edge 10 according to one embodiment.

FIG. 4 illustrates a top view of the interior surface lining showing the second interior lining face 11, the first transverse interior lining edge 7, the second transverse interior lining edge 8, the first longitudinal interior lining edge 9, and the second longitudinal interior lining edge 10 according to one embodiment. FIG. 4 illustrates the opposite interior lining face as illustrated in FIG. 3 by rotating FIG. 3 180-degrees around the longitudinal axis to reverse the left and right positions of the longitudinal edges.

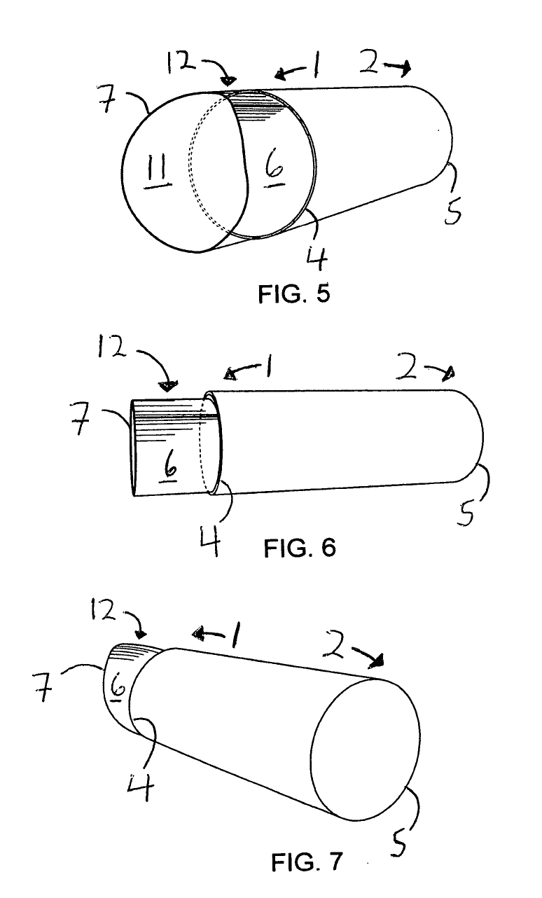

FIG. 5 illustrates a perspective side view of the compartment anterior end 1 where the interior surface lining is deeply inserted into the compartment and where the first interior lining face 6 is coupled to about the whole interior surface of the compartment according to one embodiment. The compartment posterior end 2, the circumference of the anterior end 4, the circumference of the posterior end 5, the first transverse interior lining edge 7, the second interior lining face 11, and the interior access flap 12 are also clearly distinguishable in this illustration.

FIG. 6 illustrates a perspective side view of the compartment where the interior surface lining is deeply inserted into the compartment, where the first interior lining face 6 is coupled to about the whole interior surface of the compartment, where the second transverse interior lining edge 8 is oriented substantially in alignment with and in a longitudinally parallel plane to the circumference of the posterior end 5, and where the first transverse interior lining edge 7 is oriented in a longitudinally parallel plane to the circumference of the anterior end 4 and longitudinally externally beyond the anterior end 1 of the compartment sufficiently distant that it is about 70% of the outer diameter length of the compartment away creating an interior access flap 12 according to one embodiment. FIG. 6 illustrates a more direct perspective side view of FIG. 5.

FIG. 7 illustrates a perspective side view of the compartment posterior end 2 where the interior surface lining is deeply inserted into the compartment and where the first interior lining face 6 is coupled to about the whole interior surface of the compartment according to one embodiment. The compartment anterior end 1, the circumference of the anterior end 4, the circumference of the posterior end 5, the first transverse interior lining edge 7, and the interior access flap 12 are also clearly distinguishable in this illustration. FIG. 7 illustrates a more posterior perspective side view of FIG. 5 and FIG. 6.

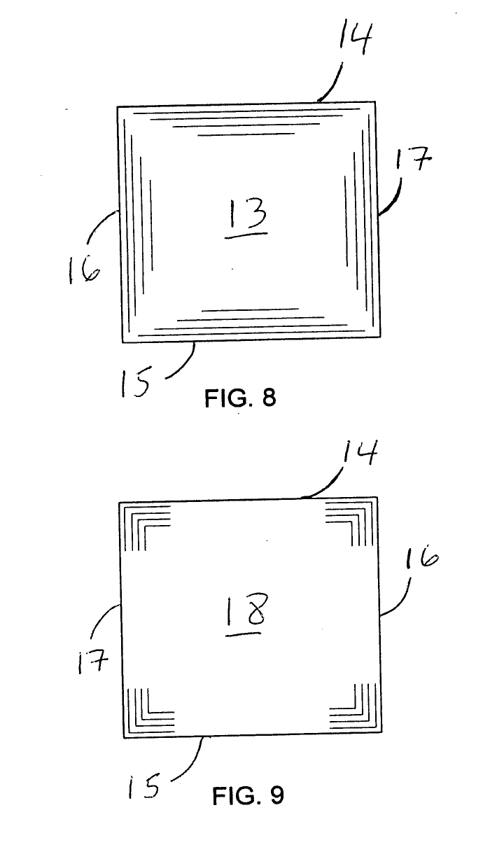

FIG. 8 illustrates a top view of the exterior surface lining showing the first exterior lining face 13, the first transverse exterior lining edge 14, the second transverse exterior lining edge 15, the first longitudinal exterior lining edge 16, and the second longitudinal exterior lining edge 17 according to one embodiment.

FIG. 9 illustrates a top view of the exterior surface lining showing the second exterior lining face 18, the first transverse exterior lining edge 14, the second transverse exterior lining edge 15, the first longitudinal exterior lining edge 16, and the second longitudinal exterior lining edge 17 according to one embodiment. FIG. 9 illustrates the opposite side exterior lining face as illustrated in FIG. 8 by rotating FIG. 8 180-degrees around the longitudinal axis to reverse the left and right positions of the longitudinal edges.

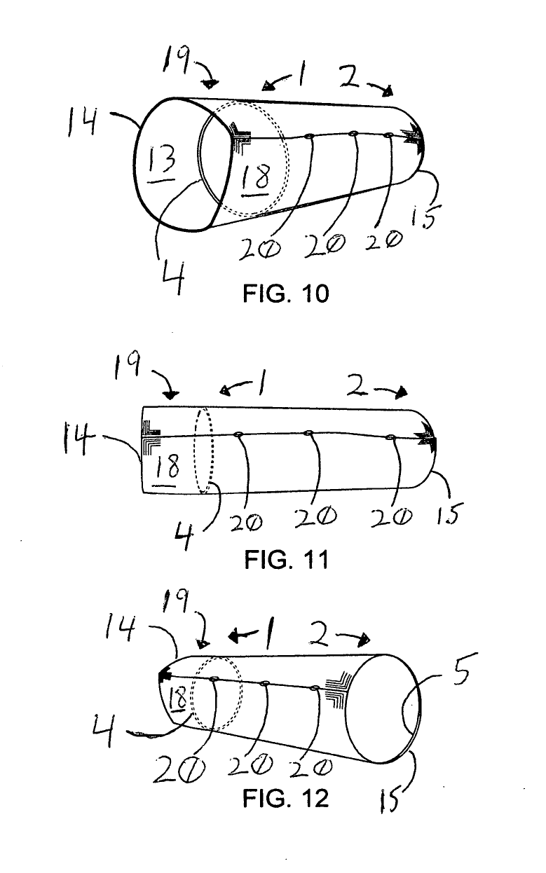

FIG. 10 illustrates a perspective side view of the compartment anterior end 1 where the first exterior lining face 13 of the exterior surface lining is coupled to about the whole exterior surface of the compartment according to one embodiment. The compartment posterior end 2, the circumference of the anterior end 4, the first transverse exterior lining edge 14, the second transverse exterior lining edge 15, the second exterior lining face 18, the exterior access flap 19, and portions of adhesive 20 are also clearly distinguishable in this illustration.

FIG. 11 illustrates a perspective side view of the compartment where the first exterior lining face 13 of the exterior surface lining is coupled to about the whole exterior surface of the compartment, where the second transverse exterior lining edge 15 is oriented substantially in alignment with and in a longitudinally parallel plane to the circumference of the posterior end 5, and where the first transverse exterior lining edge 14 is oriented in a longitudinally parallel plane to the circumference of the anterior end 4 and longitudinally externally beyond the anterior end 1 of the compartment sufficiently distant that it is about 70% of the outer diameter length of the compartment away creating an exterior access flap 19 according to one embodiment. FIG. 11 illustrates a more direct perspective side view of FIG. 10.

FIG. 12 illustrates a perspective side view of the compartment posterior end 2 where the first exterior lining face 13 of the exterior surface lining is coupled to about the whole exterior surface of the compartment according to one embodiment. The compartment anterior end 1, the compartment posterior end 2, the circumference of the anterior end 4, the circumference of the posterior end 5, the first transverse exterior lining edge 14, the second transverse exterior lining edge 15, the second exterior lining face 18, the exterior access flap 19, and portions of adhesives 20 are also clearly distinguishable in this illustration. FIG. 12 illustrates a more posterior perspective side view of FIG. 10 and FIG. 11.

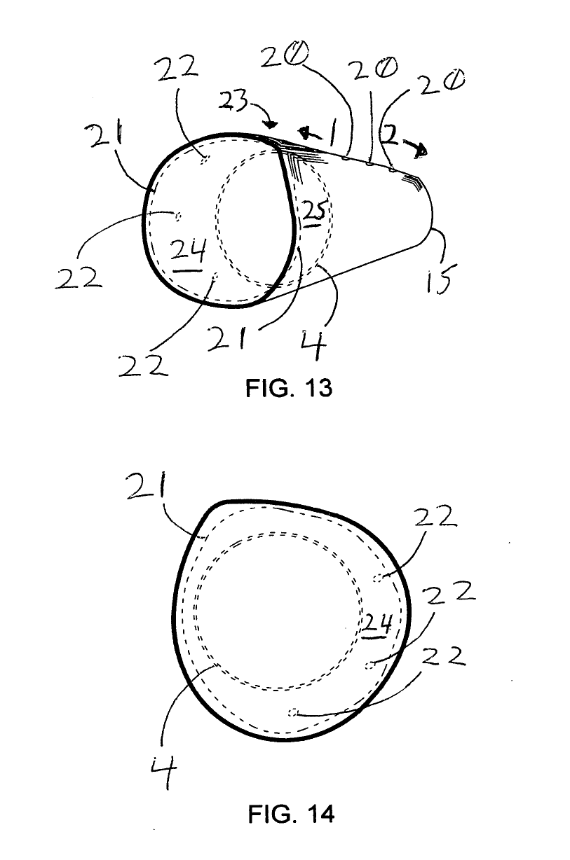

FIG. 13 illustrates a perspective side view of the storage case anterior end where a section of stitching 21 transverses the interior access flap 12 and the exterior access flap 19 as a means to create a coupled access flap 23 and where portions of adhesive 22 are applied between the interior access flap 12 and the exterior access flap 19 as a means to create a coupled access flap 23 which is comprised of a coupled access flap interior lining face 24 and a coupled access flap exterior lining face 25.

FIG. 14 illustrates a perspective top view inside the storage case anterior end where a section of stitching 21 transverses the interior access flap 12 and the exterior access flap 19 as a means to create a coupled access flap 23 and where portions of adhesive 22 are applied between the interior access flap 12 and the exterior access flap 19 as a means to create a coupled access flap 23 which is comprised of a coupled access flap interior lining face 24 and a coupled access flap exterior lining face 25. FIG. 14 is a different view of FIG. 13.

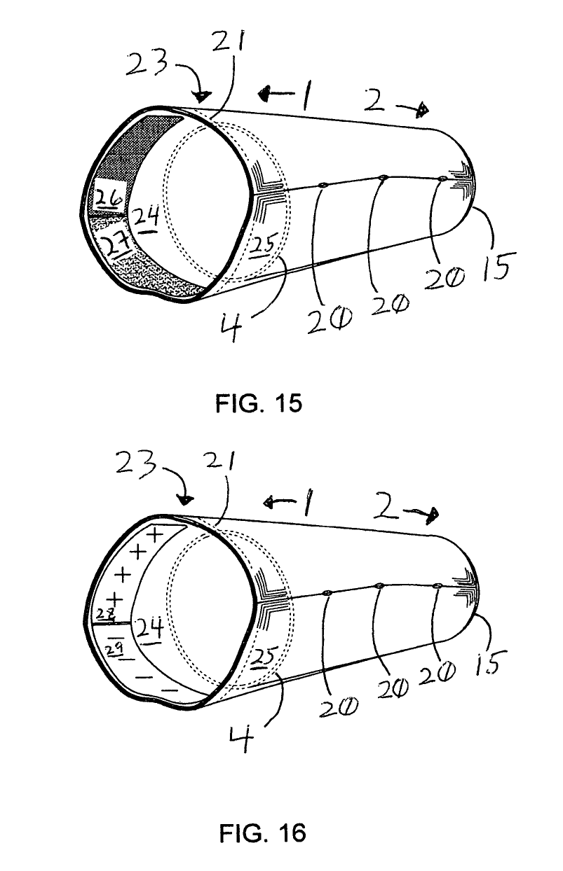

FIG. 15 illustrates a perspective side view of the storage case anterior end where an access flap fabric hook fastener piece 26 and an access flap fabric loop fastener piece 27 are coupled to the coupled access flap interior lining face 24 in a corporate way creating a means for fastening the coupled access flap according to the best mode embodiment.

FIG. 16 illustrates a perspective side view of the storage case anterior end where an access flap positive pole magnet member 28 and an access flap negative pole magnet member 29 are coupled to the coupled access flap interior lining face 24 in a corporate way creating a means for fastening the coupled access flap according to one embodiment.

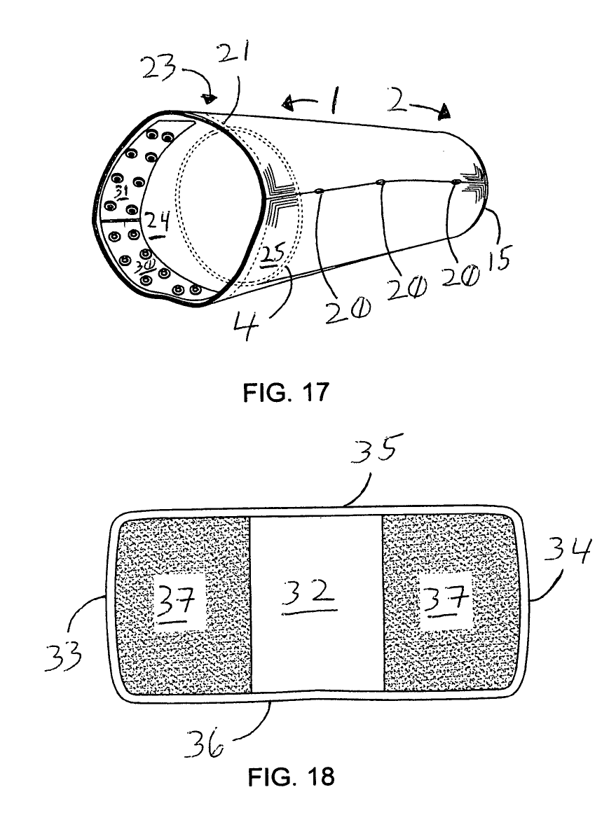

FIG. 17 illustrates a perspective side view of the storage case anterior end where an access flap male snap button member 30 and an access flap female snap button member 31 are coupled to the coupled access flap interior lining face 24 in a corporate way creating a means for fastening the coupled access flap according to one embodiment.

FIG. 18 illustrates a top view of the connecting baseplate showing the first slab face 32, the first transverse slab edge 33, the second transverse slab edge 34, the first longitudinal slab edge 35, and the second longitudinal slab edge 36 according to the best mode embodiment. This embodiment also illustrates the cooperative first interface fabric loop fastener pieces 37 coupled to the connecting baseplate that provide a means for coupling the first slab face 32 with the second strap face 44 by cooperating with the first interface fabric hook fastener piece 52.

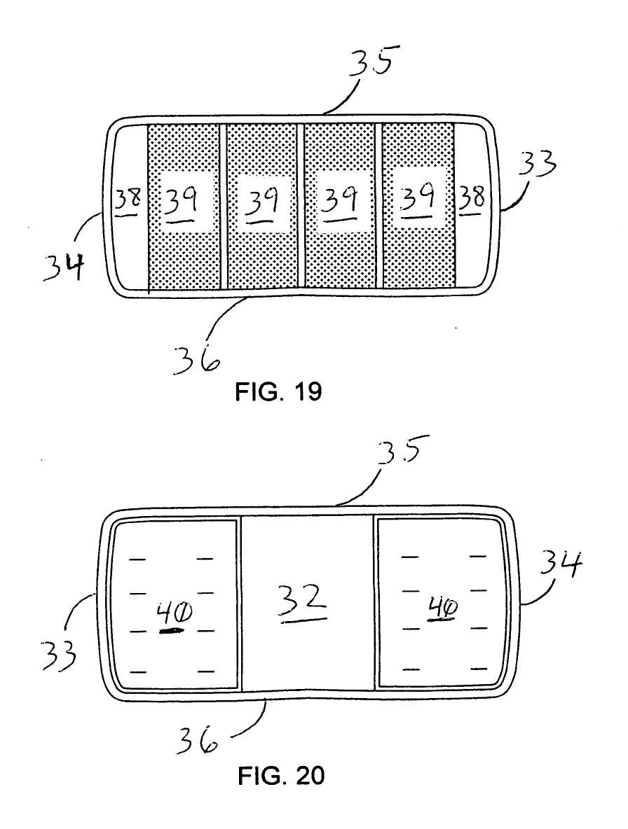

FIG. 19 illustrates a top view of the connecting baseplate showing the second slab face 38, the first transverse slab edge 33, the second transverse slab edge 34, the first longitudinal slab edge 35, and the second longitudinal slab edge 36 according to the best mode embodiment. This embodiment also illustrates the cooperative second interface fabric hook fastener pieces 39 coupled to the connecting baseplate that provide a means for coupling the second slab face 38 with the storage case by cooperating with the second interface fabric loop fastener piece 59. FIG. 19 illustrates the opposite side slab face as illustrated in FIG. 18 by rotating FIG. 18 180-degrees around the transverse axis to reverse the left and right positions of the transverse edges.

FIG. 20 illustrates a top view of the connecting baseplate showing the first slab face 32, the first transverse slab edge 33, the second transverse slab edge 34, the first longitudinal slab edge 35, and the second longitudinal slab edge 36 according to one embodiment. This embodiment also illustrates the cooperative first interface negative pole magnet members 40 coupled to the connecting baseplate that provide a means for coupling the first slab face 32 with the second strap face 44 by cooperating with the first interface positive pole magnet member 55.

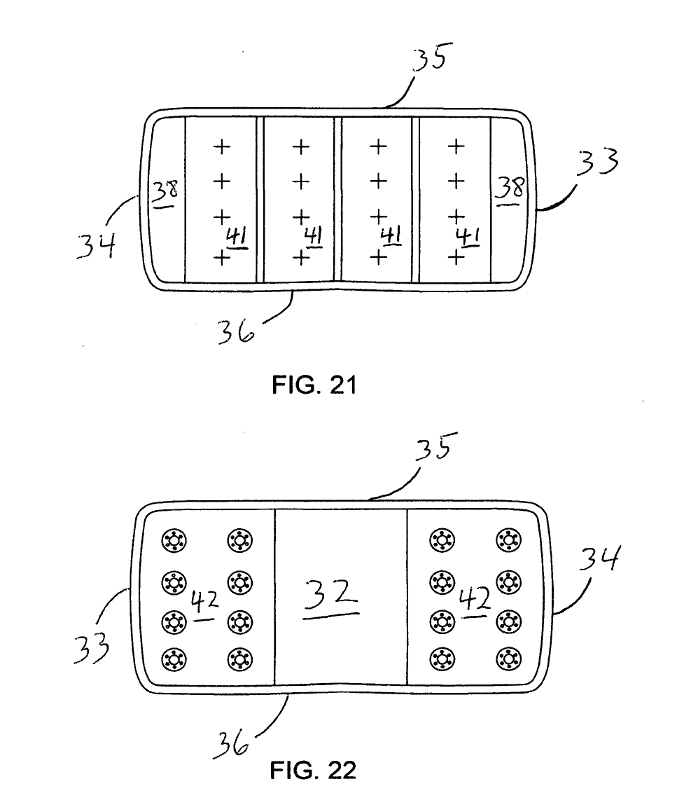

FIG. 21 illustrates a top view of the connecting baseplate showing the second slab face 38, the first transverse slab edge 33, the second transverse slab edge 34, the first longitudinal slab edge 35, and the second longitudinal slab edge 36 according to one embodiment. This embodiment also illustrates the cooperative second interface positive pole magnet members 41 coupled to the connecting baseplate that provide a means for coupling the second slab face 38 with the storage case by cooperating with the second interface negative pole magnet member 60. FIG. 21 illustrates the opposite side slab face as illustrated in FIG. 20 by rotating FIG. 20 180-degrees around the transverse axis to reverse the left and right positions of the transverse edges.

FIG. 22 illustrates a top view of the connecting baseplate showing the first slab face 32, the first transverse slab edge 33, the second transverse slab edge 34, the first longitudinal slab edge 35, and the second longitudinal slab edge 36 according to one embodiment. This embodiment also illustrates the cooperative first interface male snap button members 42 coupled to the connecting baseplate that provide a means for coupling the first slab face 32 with the second strap face 44 by cooperating with the first interface female snap button members 58.

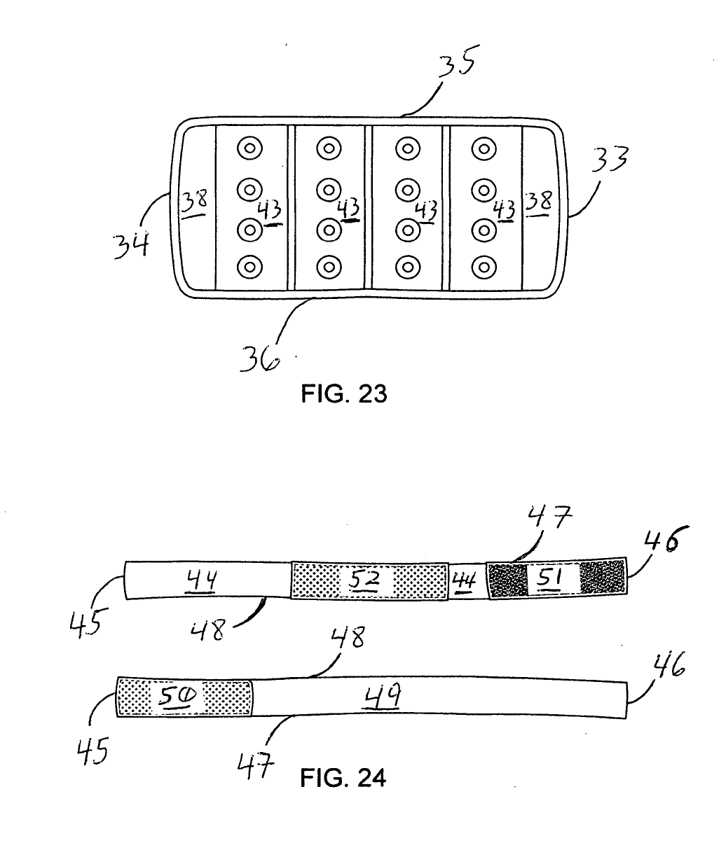

FIG. 23 illustrates a top view of the connecting baseplate showing the second slab face 38, the first transverse slab edge 33, the second transverse slab edge 34, the first longitudinal slab edge 35, and the second longitudinal slab edge 36 according to one embodiment. This embodiment also illustrates the cooperative second interface female snap button members 43 coupled to the connecting baseplate that provide a means for coupling the second slab face 38 with the storage case by cooperating with the second interface male snap button members 61. FIG. 23 illustrates the opposite side slab face as illustrated in FIG. 22 by rotating FIG. 22 180-degrees around the transverse axis to reverse the left and right positions of the transverse edges.

FIG. 24 illustrates a top view of two connecting straps where the first strap located on the top shows the second strap face 44, the first transverse strap edge 45, the second transverse strap edge 46, the first longitudinal strap edge 47, and the second longitudinal strap edge 48 according to the best mode embodiment. The second connecting strap located on the bottom illustrates the opposite side of the connecting strap located on the top and shows the first strap face 49, the first transverse strap edge 45, the second transverse strap edge 46, the first longitudinal strap edge 47, and the second longitudinal strap edge 48 according to the best mode embodiment. This embodiment illustrates the cooperative strap face coupling fabric hook fastener piece 50 and strap face coupling fabric loop fastener piece 51 coupled to the connecting straps that provide a means for coupling the first strap face 49 with the second strap face 44 and a first interface fabric hook fastener piece 52 for coupling the second strap face 44 with the first slab face 32.

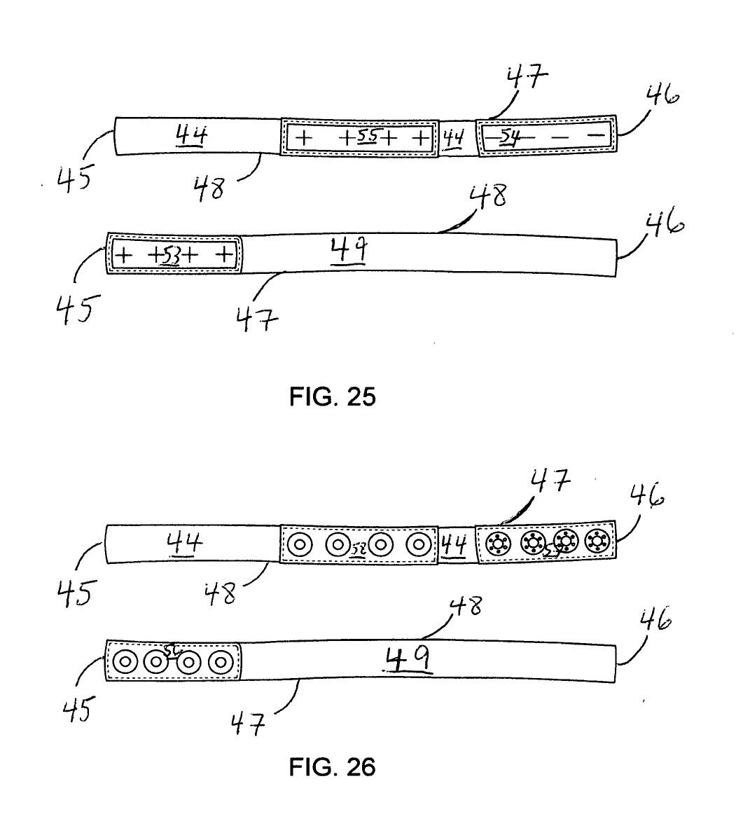

FIG. 25 illustrates a top view of two connecting straps where the first strap located on the top shows the second strap face 44, the first transverse strap edge 45, the second transverse strap edge 46, the first longitudinal strap edge 47, and the second longitudinal strap edge 48 according to one embodiment. The second connecting strap located on the bottom illustrates the opposite side of the connecting strap located on the top and shows the first strap face 49, the first transverse strap edge 45, the second transverse strap edge 46, the first longitudinal strap edge 47, and the second longitudinal strap edge 48 according to one embodiment. This embodiment illustrates the cooperative strap face coupling positive pole magnet member 53 and a strap face coupling negative pole magnet member 54 coupled to the connecting straps that provide a means for coupling the first strap face 49 with the second strap face 44 and a first interface positive pole magnet member 55 for coupling the second strap face 44 with the first slab face 32.

FIG. 26 illustrates a top view of two connecting straps where the first strap located on the top shows the second strap face 44, the first transverse strap edge 45, the second transverse strap edge 46, the first longitudinal strap edge 47, and the second longitudinal strap edge 48 according to one embodiment. The second connecting strap located on the bottom illustrates the opposite side of the connecting strap located on the top and shows the first strap face 49, the first transverse strap edge 45, the second transverse strap edge 46, the first longitudinal strap edge 47, and the second longitudinal strap edge 48 according to one embodiment. This embodiment illustrates the cooperative strap face coupling female snap button members 56 and strap face coupling male snap button members 57 coupled to the connecting straps that provide a means for coupling the first strap face 49 with the second strap 44 face and first interface female snap button members 58 for coupling the second strap face 44 with the first slab face 32.

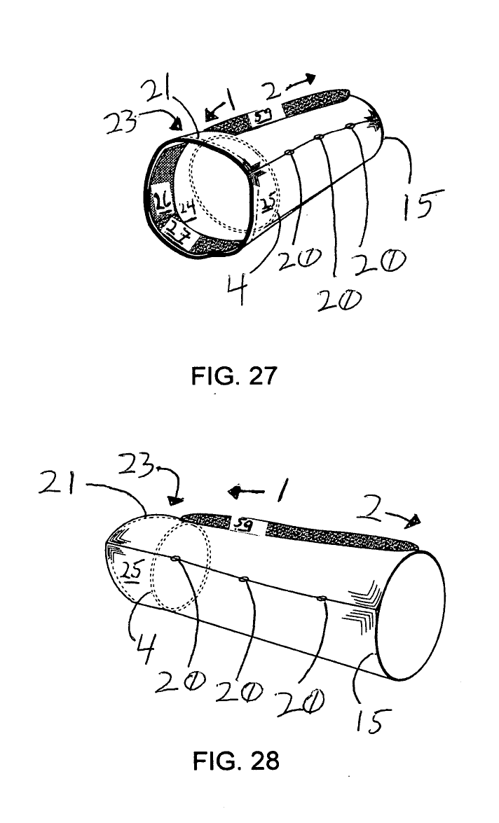

FIG. 27 illustrates a perspective side view of the storage case anterior end as shown in FIG. 15 but that now additionally illustrates the second interface fabric loop fastener piece 59 coupled to the storage case exterior creating a means of coupling the storage case with the second interface fabric hook fastener piece 39 of the connecting baseplate or with the first interface fabric hook fastener piece 52 of the connecting strap according to the best mode embodiment.

FIG. 28 illustrates a perspective side view of the storage case posterior end as a more posterior perspective side view of FIG. 27.

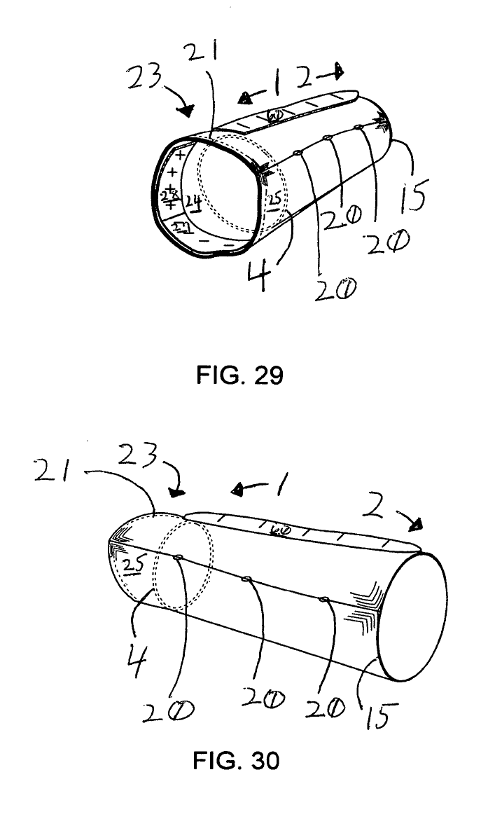

FIG. 29 illustrates a perspective side view of the storage case anterior end as shown in FIG. 16 but that now additionally illustrates the second interface negative pole magnet member 60 coupled to the storage case exterior creating a means of coupling the storage case with the second interface positive pole magnet members 41 of the connecting baseplate or with the first interface positive pole magnet member 55 of the connecting strap according to one embodiment.

FIG. 30 illustrates a perspective side view of the storage case posterior end as a more posterior perspective side view of FIG. 29.

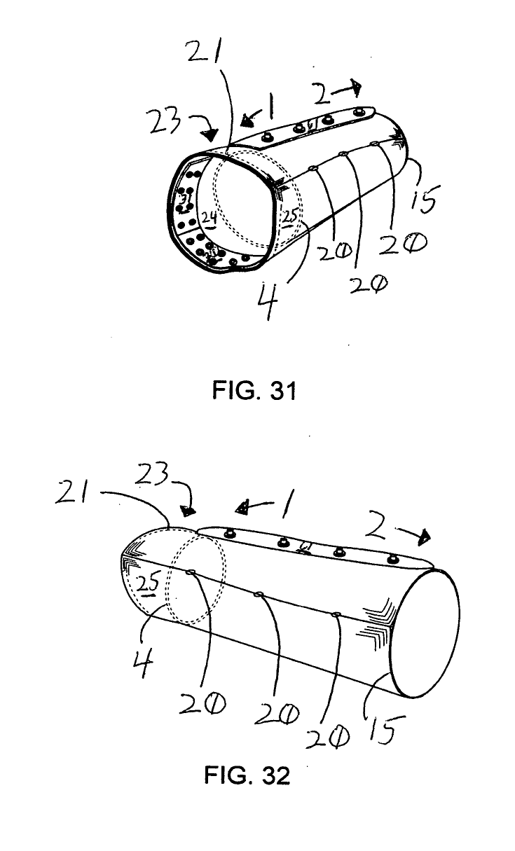

FIG. 31 illustrates a perspective side view of the storage case anterior end as shown in FIG. 17 but that now additionally illustrates second interface male snap button members 61 coupled to the storage case exterior creating a means of coupling the storage case with the second interface female snap button members 43 of the connecting baseplate or with the first interface female snap button members 58 of the connecting strap according to one embodiment.

FIG. 32 illustrates a perspective side view of the storage case posterior end as a more posterior perspective side view of FIG. 31.

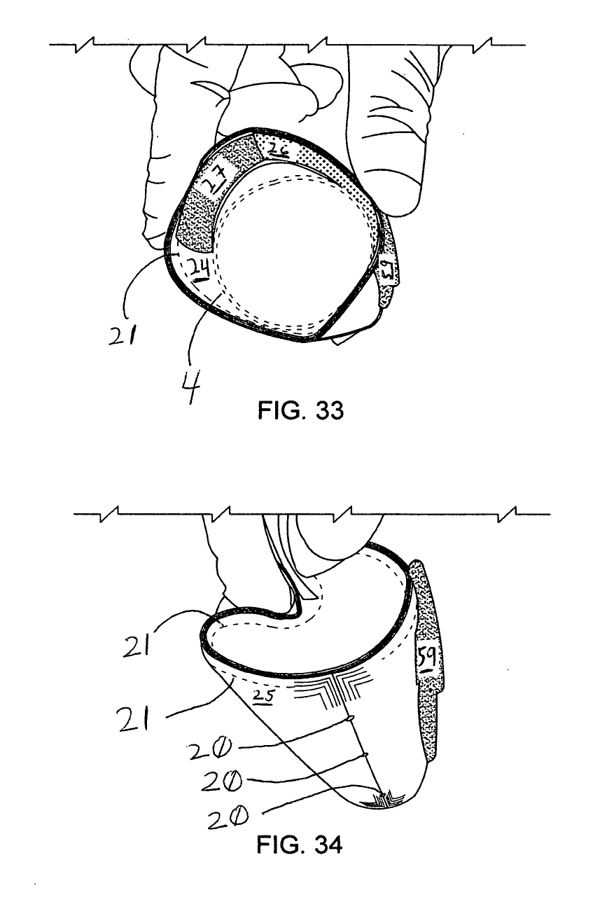

FIG. 33 illustrates a perspective top view inside the storage case anterior end and shows a method of fastening the coupled access flap 23 that involves a fastening pinch action with the thumb and fingers over the coupled access flap exterior lining face 25 to bring the access flap fabric hook fastener piece 26 and the access flap fabric loop fastener piece 27 into contact with each other according to the best mode embodiment. FIG. 33 is a different view of FIG. 27.

FIG. 34 illustrates a perspective top view inside the storage case anterior end and shows a continuation of the method of fastening the coupled access flap 23 initiated in FIG. 33.

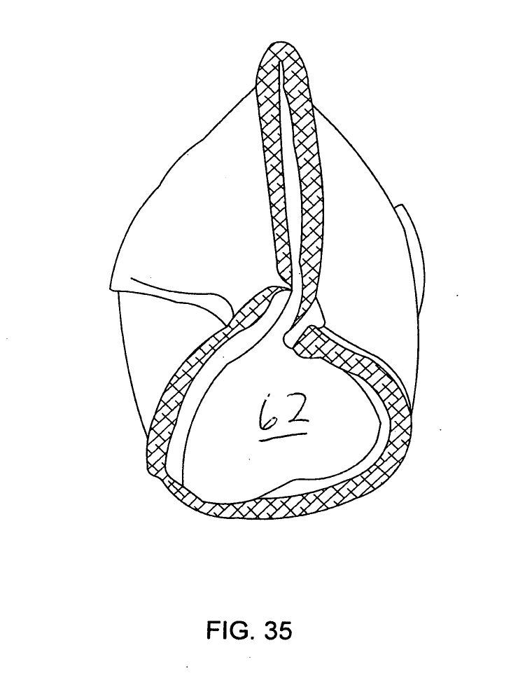

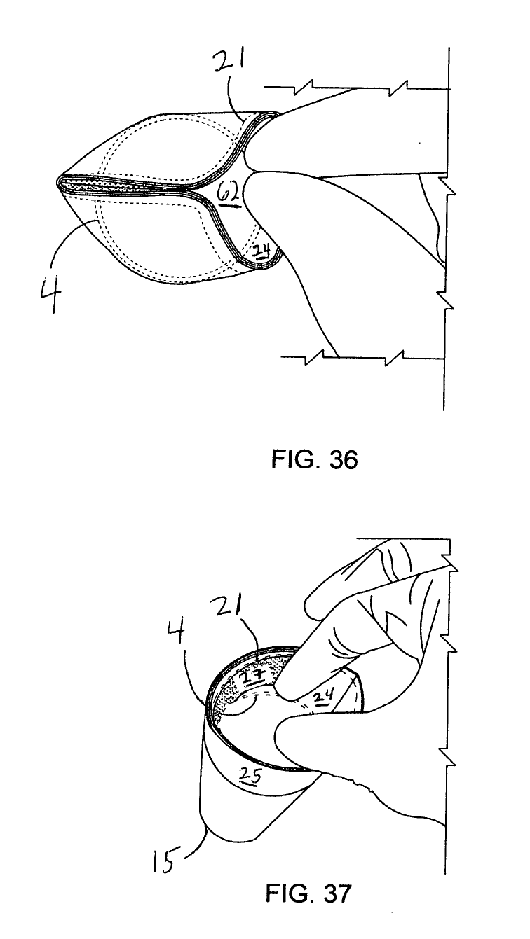

FIG. 35 illustrates a perspective top view of the storage case anterior end and shows the opening access hole 62 created when the coupled access flap 23 is fastened according to the best mode embodiment.

FIG. 36 illustrates a perspective top view of the storage case anterior end and shows a method of opening the coupled access flap 23 that involves an opening reverse-pinch action with the thumb and fingers inside the opening access hole 62 to separate the access flap fabric hook fastener piece 26 and the access flap fabric loop fastener piece 27 from contact with each other according to the best mode embodiment.

FIG. 37 illustrates a perspective top view of the storage case anterior end and shows a continuation of the method of opening the coupled access flap initiated in FIG. 36.

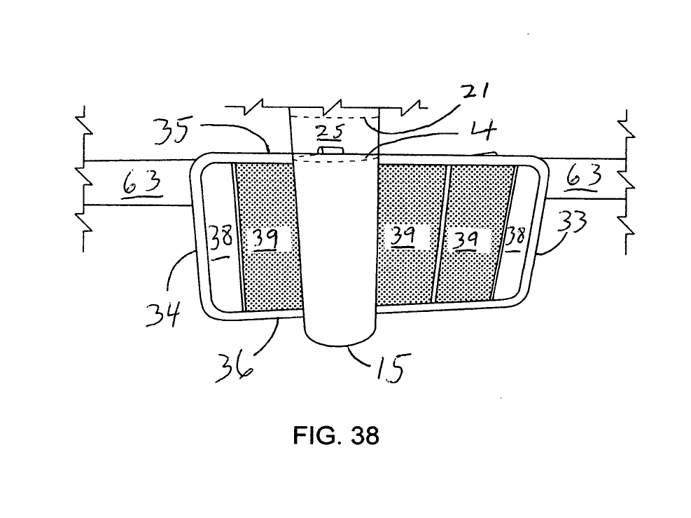

FIG. 38 illustrates a perspective front view of the storage case, connecting baseplate, and connecting straps coupled to a substrate 63 showing a method of using all in cooperation with each other according to the best mode embodiment. One or more connecting straps are coupled onto the desired substrate 63 where the connecting baseplate is coupled with the one or more connecting straps where one or more storage cases are coupled with the connecting baseplate.

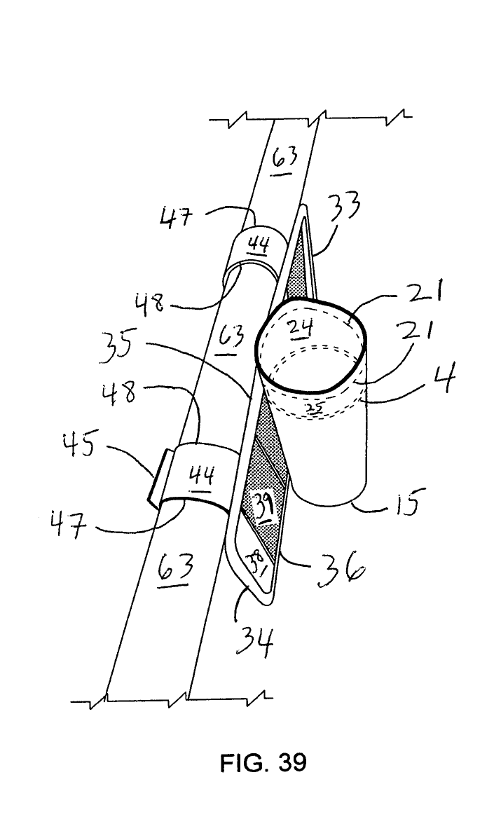

FIG. 39 illustrates a perspective left side view of the storage case, connecting baseplate, and connecting straps coupled to a substrate 63 showing a method of using all in cooperation with each other according to the best mode embodiment. One or more connecting straps are coupled onto the desired substrate 63 where the connecting baseplate is coupled with the one or more connecting straps where one or more storage cases are coupled with the connecting baseplate. FIG. 39 illustrates a more perspective left side view of FIG. 38 and more clearly shows the connecting straps coupled to the desired substrate 63.

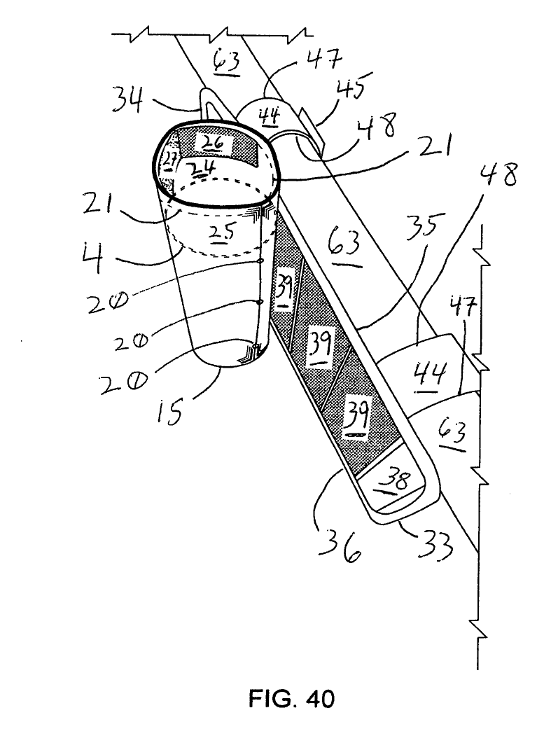

FIG. 40 illustrates a perspective right side view of the storage case, connecting baseplate, and connecting straps coupled to a substrate 63 showing a method of using all in cooperation with each other according to the best mode embodiment. One or more connecting straps are coupled onto the desired substrate 63 where the connecting baseplate is coupled with the one or more connecting straps where one or more storage cases are coupled with the connecting baseplate. FIG. 40 illustrates a more perspective right side view of FIG. 38 and more clearly shows the connecting straps coupled to the desired substrate 63.

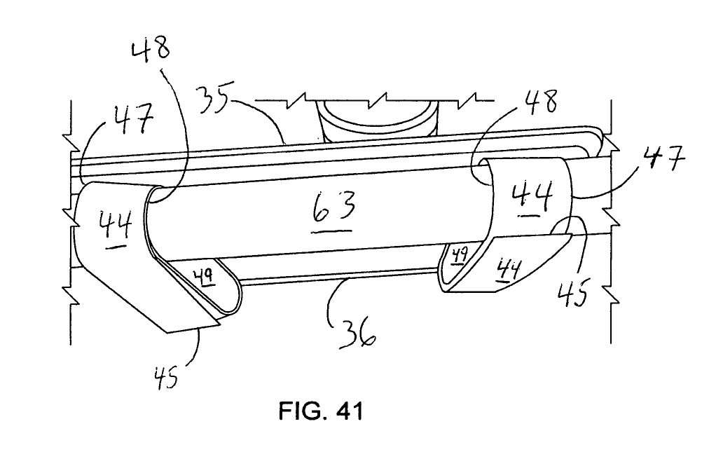

FIG. 41 illustrates a perspective rear view of the storage case, connecting baseplate, and connecting straps coupled to a substrate 63 showing a method of using all in cooperation with each other according to the best mode embodiment. One or more connecting straps are coupled onto the desired substrate 63 where the connecting baseplate is coupled with the one or more connecting straps where one or more storage cases are coupled with the connecting baseplate. FIG. 41 illustrates a more perspective rear view of FIG. 38 and more clearly shows the connecting straps coupled to the desired substrate 63.

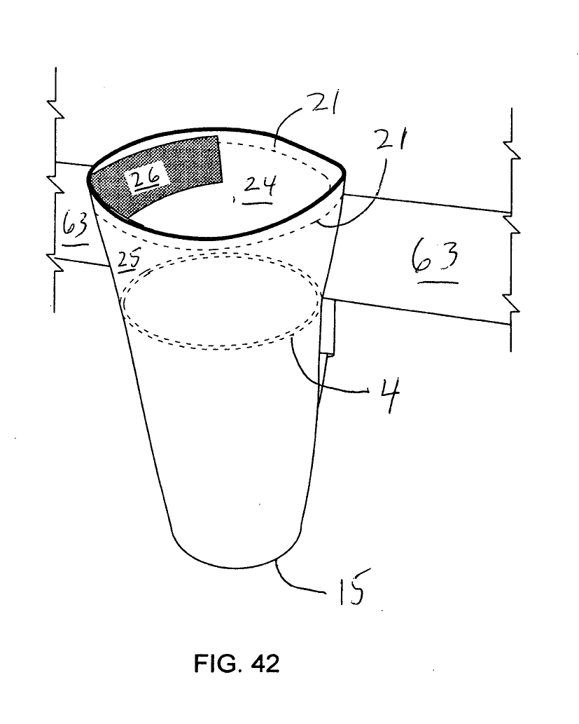

FIG. 42 illustrates a perspective front view of the storage case and connecting strap coupled to a substrate 63 showing a method of using all in cooperation with each other according to the best mode embodiment. One or more connecting straps are coupled onto the desired substrate 63 where one or more storage cases are coupled with the connecting straps.

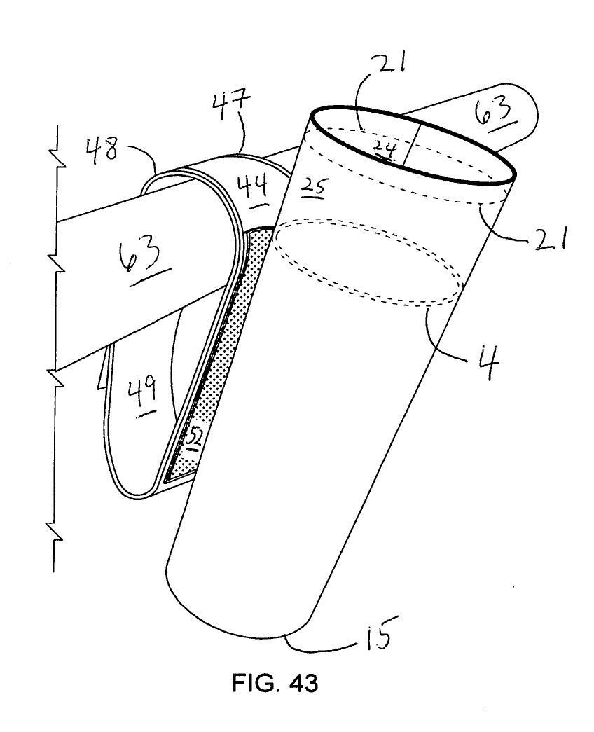

FIG. 43 illustrates a perspective left side view of the storage case and connecting strap coupled to a substrate 63 showing a method of using all in cooperation with each other according to the best mode embodiment. One or more connecting straps are coupled onto the desired substrate 63 where one or more storage cases are coupled with the connecting straps. FIG. 43 illustrates a more perspective left side view of FIG. 42 and more clearly shows the connecting strap coupled to the desired substrate 63.

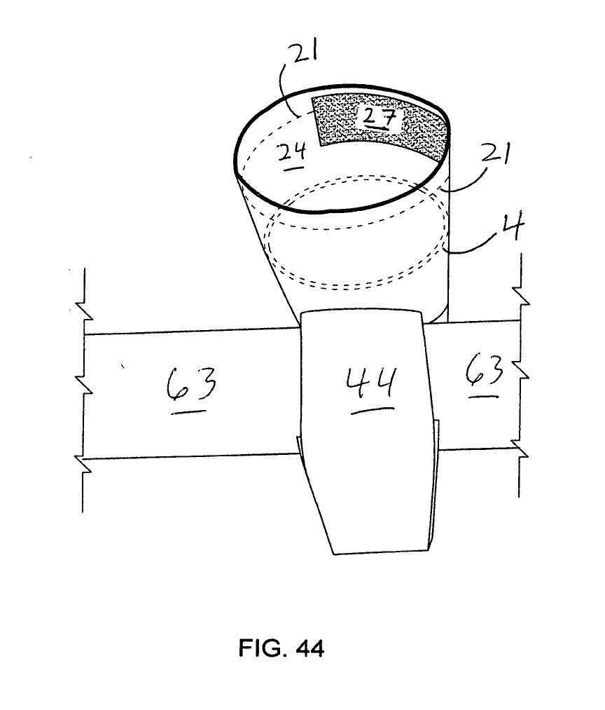

FIG. 44 illustrates a perspective rear view of the storage case and connecting strap coupled to a substrate 63 showing a method of using all in cooperation with each other according to the best mode embodiment. One or more connecting straps are coupled onto the desired substrate 63 where one or more storage cases are coupled with the connecting straps. FIG. 44 illustrates a more perspective rear view of FIG. 42 and more clearly shows the connecting strap coupled to the desired substrate 63.

The invention claimed is:

1. A storage case comprising,
a compartment substantially tubular in shape and uniform in diameter characterized by an anterior end and a posterior end separated longitudinally, said compartment further characterized by an open clearance at said anterior end that is substantially equal in circumference to the circumference of said compartment,
an interior surface lining substantially rectangular in shape comprising flexible material, said interior surface lining further comprising a first transverse interior lining edge, a second transverse interior lining edge, a first longitudinal interior lining edge, a second longitudinal interior lining edge, a first interior lining face, and a second interior lining face, said first interior lining face coupled to about the whole interior surface of said compartment, said first transverse interior lining edge oriented in a longitudinally parallel plane to the circumference of said anterior end, said first transverse interior lining edge further oriented longitudinally externally beyond said anterior end sufficiently distant that it is about 70% of the outer diameter length of said compartment away creating an interior access flap, said second transverse interior lining edge oriented in a longitudinally parallel plane to the circumference of said posterior end, said second transverse interior lining edge further oriented longitudinally substantially in alignment with said posterior end,
an exterior surface lining substantially rectangular in shape comprising flexible material, said exterior surface lining further comprising a first transverse exterior lining edge, a second transverse exterior lining edge, a first longitudinal exterior lining edge, a second longitudinal exterior lining edge, a first exterior lining face, and a second exterior lining face, said first exterior lining face coupled to about the whole exterior surface of said compartment, said first transverse exterior lining edge oriented in a longitudinally parallel plane to the circumference of said anterior end, said first transverse exterior lining edge further oriented longitudinally externally beyond said anterior end sufficiently distant that it is about 70% of the outer diameter length of said compartment away creating an exterior access flap, said second transverse exterior lining edge oriented in a longitudinally parallel plane to the circumference of said posterior end, said second transverse exterior lining edge further oriented longitudinally substantially in alignment with said posterior end.

2. A means for coupling said interior access flap with said exterior access flap comprising,
a section of stitching that transverses said interior access flap and said exterior access flap creating a coupled access flap, said coupled access flap comprising a coupled access flap interior lining face and a coupled access flap exterior lining face, and/or
an adhesive applied to said first interior lining face of said interior access flap and to said first exterior lining face of said exterior access flap creating a coupled access flap, said coupled access flap comprising a coupled access flap interior lining face and a coupled access flap exterior lining face.

3. A means for fastening said coupled access flap comprising,
an access flap fabric hook fastener piece, sufficiently long that it is about 21% of the inner circumference length of said compartment, coupled to said coupled access flap interior lining face configured to cooperate with an access flap fabric loop fastener piece, sufficiently long that it is about 21% of the inner circumference length of said compartment, coupled to said coupled access flap interior lining face creating an opening access hole when fastened together.

4. A means for fastening said coupled access flap according to claim 3 wherein said access flap fabric hook fastener piece and said access flap fabric loop fastener piece are replaced by elements comprising a cooperative access flap positive pole magnet member and an access flap negative pole magnet member fastener.

5. A means for fastening said coupled access flap according to claim 3 wherein said access flap fabric hook fastener piece and said access flap fabric loop fastener piece are replaced by elements comprising a cooperative access flap male snap button member and access flap female snap button member fastener.

6. A connecting baseplate comprising,
a slab substantially rectangular in shape comprising natural or synthetic or composite material, said slab further comprising a first transverse slab edge, a second transverse slab edge, a first longitudinal slab edge, a second longitudinal slab edge, a first slab face, and a second slab face.

7. A connecting strap comprising,
a flexible material substantially rectangular in shape, said strap further comprising a first transverse strap edge, a second transverse strap edge, a first longitudinal strap edge, a second longitudinal strap edge, a first strap face, and a second strap face.

8. A means for coupling said first strap face with said second strap face comprising,
a strap face coupling fabric hook fastener piece coupled to said first strap face configured to cooperate with a strap face coupling fabric loop fastener piece coupled to said second strap face, or
a strap face coupling fabric loop fastener piece coupled to said first strap face configured to cooperate with a strap face coupling fabric hook fastener piece coupled to said second strap face.

9. A means for coupling said first strap face with said second strap face according to claim 8 wherein said strap face coupling fabric hook fastener piece and said strap face coupling fabric loop fastener piece are replaced by elements comprising a cooperative strap face coupling positive pole magnet member and a strap face coupling negative pole magnet member coupler.

10. A means for coupling said first strap face with said second strap face according to claim 8 wherein said strap face coupling fabric hook fastener piece and said strap face coupling fabric loop fastener piece are replaced by elements comprising cooperative strap face coupling male snap button members and strap face coupling female snap button members couplers.

11. A means for coupling said second strap face with said first slab face comprising,
a first interface fabric hook fastener piece coupled to said second strap face configured to cooperate with a first interface fabric loop fastener piece coupled to said first slab face, or
a first interface fabric loop fastener piece coupled to said second strap face configured to cooperate with a first interface fabric hook fastener piece coupled to said first slab face.

12. A means for coupling said second strap face with said first slab face according to claim 11 wherein said first interface fabric hook fastener piece and said first interface fabric loop fastener piece are replaced by elements comprising a cooperative first interface positive pole magnet member and a first interface negative pole magnet member coupler.

13. A means for coupling said second strap face with said first slab face according to claim 11 wherein said first interface fabric hook fastener piece and said first interface fabric loop fastener piece are replaced by elements comprising cooperative first interface male snap button members and first interface female snap button members couplers.

14. A means for coupling said second slab face with said storage case comprising,
a second interface fabric hook fastener piece coupled to said second slab face configured to cooperate with a second interface fabric loop fastener piece coupled to said storage case, or
a second interface fabric loop fastener piece coupled to said second slab face configured to cooperate with a second interface fabric hook fastener piece coupled to said storage case.

15. A means for coupling said second slab face with said storage case according to claim 14 wherein said second interface fabric hook fastener piece and said second interface fabric loop fastener piece are replaced by elements comprising a cooperative second interface positive pole magnet member and a second interface negative pole magnet member coupler.

16. A means for coupling said second slab face with said storage case according to claim 14 wherein said second interface fabric hook fastener piece and said second interface fabric loop fastener piece are replaced by elements comprising cooperative second interface female snap button members and second interface male snap button members couplers.

17. A method of fastening and opening said coupled access flap comprising,
a fastening pinch action with the thumb and fingers over said coupled access flap exterior lining face to bring said access flap fabric hook fastener piece and said access flap fabric loop fastener piece into contact with each other, and
an opening reverse-pinch action with the thumb and fingers inside said opening access hole to separate said access flap fabric hook fastener piece and said access flap fabric loop fastener piece from contact with each other.

18. A method of using one or more of said connecting straps, said connecting baseplate, and one or more of said storage cases in cooperation with each other comprising,
a coupling of one or more of said connecting straps onto a vehicle sun visor or other desired substrate by bringing said strap face coupling fabric hook fastener piece and said strap face coupling fabric loop fastener piece into contact with each other, and
a coupling of said connecting baseplate with one or more of said connecting straps by bringing said first interface fabric hook fastener piece and said first interface fabric loop fastener piece into contact with each other, and
a coupling of one or more of said storage cases with said connecting baseplate by bringing said second interface fabric hook fastener piece and said second interface fabric loop fastener piece into contact with each other.

19. A method of using one or more of said connecting straps and one or more of said storage cases in cooperation with each other comprising,
a coupling of one or more of said connecting straps onto a vehicle sun visor or other desired substrate by bringing said strap face coupling fabric hook fastener piece and said strap face coupling fabric loop fastener piece into contact with each other, and
a coupling of one or more of said storage cases with one or more of said connecting straps by bringing said first interface fabric hook fastener piece and said second interface fabric loop fastener piece into contact with each other, and/or
a coupling of one or more of said storage cases with one or more of said connecting straps by bringing said first interface fabric loop fastener piece and said second interface fabric hook fastener piece into contact with each other.
